(19) United States
(12) Patent Application Publication
(10) Pub. No.: US 2025/0087815 A1
(43) Pub. Date: Mar. 13, 2025

(54) BATTERY MODULE HAVING PRESS-FIT JOINTS FOR A VEHICLE MOUNTED RECHARGEABLE ENERGY STORAGE SYSTEM

(71) Applicant: GM Global Technology Operations LLC, Detroit, MI (US)

(72) Inventors: Alexander M. Bilinski, Avoca, MI (US); Phillip Daniel Hamelin, Clarkston, MI (US); Charles W. Mcclure, White Lake Twp, MI (US); Robert H. Dietze, Brighton, MI (US)

(21) Appl. No.: 18/462,608

(22) Filed: Sep. 7, 2023

(51) Int. Cl. H01M 50/258; H01M 10/613; H01M 10/625; H01M 10/6554; H01M 10/6568; H01M 50/209; H01M 50/249

(52) U.S. Cl. CPC H01M 50/258; H01M 10/613; H01M 10/625; H01M 10/6554; H01M 10/6568; H01M 50/209; H01M 50/249

(57) ABSTRACT

A battery module housing includes a base wall, a first side wall including a first connecting element, a second side wall including a second connecting element, and a connecting wall extending between the first side wall and the second side wall. The connecting wall includes a first side edge including a first recess aligned with the first connecting element and a second edge including a second recess aligned with the second connecting element. The first recess press-fittingly receives the first connecting element and the second recess press-fittingly receives the second connecting element to join the connecting wall to each of the first side wall and the second side wall.

### INTRODUCTION

The subject disclosure relates to the art of rechargeable batteries and, more particularly, to a battery module housing for a vehicle mounted rechargeable energy storage system.

Rechargeable battery systems often include multiple connected battery cells arranged in a module housing to form a battery module. Multiple battery modules are connected and arranged in a housing to form a battery assembly. The battery assembly may be used to provide motive power to, for example, a vehicle such as an automobile. In such an environment, the battery assembly is connected to a load, such as a drive motor and a charge port that may be connected to a source of electric energy. The battery assembly discharges into the drive motor to provide power to the vehicle and is charged through the charge port.

Each battery module is designed for a specific module housing and to house a specific number and size of battery cells. Mechanical fasteners are employed to assembly the module housings. The use of mechanical fasteners drives design and size constraints for the module housing. That is, the module housing must be designed to not only accommodate battery cells, but to also provide access for tools used to manipulate the mechanical fasteners. Accordingly, it is desirable to provide a system for joining module housing components that eliminates the need for tool access to fasteners in order to reduce module size.

### SUMMARY

A battery module housing, in accordance with a non-limiting example, includes a base wall, a first side wall including a first connecting element, a second side wall including a second connecting element, and a connecting wall extending between the first side wall and the second side wall. The connecting wall includes a first side edge including a first recess aligned with the first connecting element and a second edge including a second recess aligned with the second connecting element. The first recess press-fittingly receives the first connecting element and the second recess press-fittingly receives the second connecting element to join the connecting wall to each of the first side wall and the second side wall.

In addition to one or more of the features described herein the first side wall includes a first opening, the first connecting element extending through the first opening into the first recess formed in the connecting wall.

In addition to one or more of the features described herein the first connecting element includes a head portion and a shaft portion extending from the head portion, the shaft portion including a plurality of gripping elements that engage with the connecting wall in the first recess.

In addition to one or more of the features described herein the first side wall includes a first surface portion and a second surface portion opposite the first surface portion, the first surface portion including a recess extending about the first opening, the head portion of the first connecting element being received in the recess.

In addition to one or more of the features described herein the second side wall includes a second opening, the second connecting element extending through the second opening into the second recess formed in the connecting wall.

In addition to one or more of the features described herein the second connecting element includes a mid-section configured to be received by the second opening, a first shaft section extending from the mid-section in a first direction into the second recess of the connecting wall and a second shaft section extending from the mid-section in a second direction that is opposite the first direction.

In addition to one or more of the features described herein the first shaft section includes a first plurality of gripping members that engage with the connecting wall in the second recess and the second shaft section includes a second plurality of gripping members.

In addition to one or more of the features described herein the second side wall includes a first surface section joined to the connector member through the first shaft section and a second surface section joined to another connector member through the second shaft section.

In addition to one or more of the features described herein the first side wall includes a first side wall member, a second side wall member joined to the first side wall member, and a cooling member extending between and arranged in heat exchange contact with the first side wall member and the second side wall member.

In addition to one or more of the features described herein the base wall includes a cooling duct extending substantially parallel to each of the first side wall and the second side wall.

A vehicle, in accordance with a non-limiting example, includes a body including a passenger compartment, an electric drive motor arranged in the body, and a battery assembly including a battery module. The battery module includes a base wall, a first side wall including a first connecting element, a second side wall including a second connecting element and a connecting wall extending between the first side wall and the second side wall. The connecting wall includes a first side edge including a first recess aligned with the first connecting element and a second edge including a second recess aligned with the second connecting element. The first recess press-fittingly receives the first connecting element and the second recess press-fittingly receives the second connecting element to join the connecting wall to each of the first side wall and the second side wall.

In addition to one or more of the features described herein the first side wall includes a first opening, the first connecting element extending through the first opening into the first recess formed in the connecting wall.

In addition to one or more of the features described herein the first connecting element includes a head portion and a shaft portion extending from the head portion, the shaft portion including a plurality of gripping elements that engage with the connecting wall in the first recess.

In addition to one or more of the features described herein the first side wall includes a first surface portion and a second surface portion opposite the first surface portion, the first surface portion including a recess extending about the first opening, the head portion of the first connecting element being received in the recess.

In addition to one or more of the features described herein the second side wall includes a second opening, the second connecting element extending through the second opening into the second recess formed in the connecting wall.

In addition to one or more of the features described herein the second connecting element includes a mid-section configured to be received by the second opening, a first shaft section extending from the mid-section in a first direction into the second recess of the connecting wall and a second shaft section extending from the mid-section in a second direction that is opposite the first direction.

In addition to one or more of the features described herein the first shaft section includes a first plurality of gripping members that engage with the connecting wall in the second recess and the second shaft section includes a second plurality of gripping members.

In addition to one or more of the features described herein the second side wall includes a first surface section joined to the connector member through the first shaft section and a second surface section joined to another connector member through the second shaft section.

In addition to one or more of the features described herein the first side wall includes a first side wall member, a second side wall member joined to the first side wall member, and a cooling member extending between and arranged in heat exchange contact with the first side wall member and the second side wall member.

In addition to one or more of the features described herein the base wall includes a cooling duct extending substantially parallel to each of the first side wall and the second side wall.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly having a battery module having press-fit joints, in accordance with a non-limiting example;

FIG. 2 is a partial perspective view of a battery assembly having a battery module assembly including battery modules having press-fit joints, in accordance with a non-limiting example;

FIG. 3 is a partial perspective view of two battery modules of the battery assembly of FIG. 2, in accordance with a non-limiting example;

FIG. 4 is a disassembled view of the two battery modules of FIG. 3, in accordance with a non-limiting example;

FIG. 5 is an end view of the two battery modules of FIG. 3, in accordance with a non-limiting example; and

FIG. 6 is a plan view of a press-fit joint, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

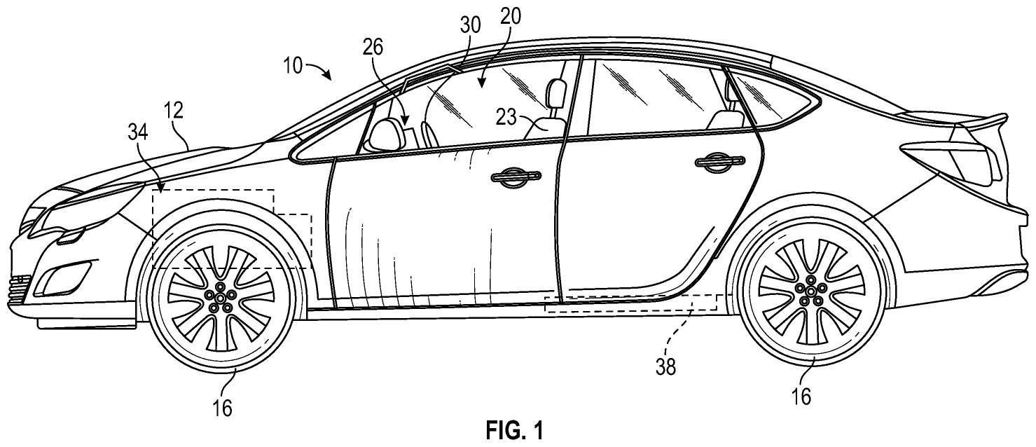

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of the steerable wheel(s). Vehicle 10 includes an electric drive motor 34 that provides power to one or more of the plurality of wheels 16.

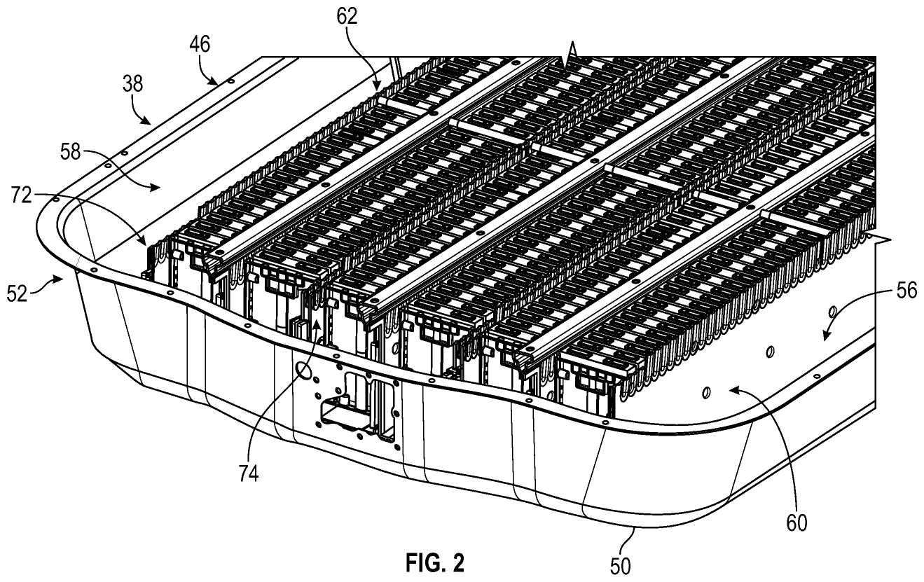

A rechargeable energy storage system (RESS) or battery assembly 38 is mounted to body 12. Battery assembly 38 provides power to electric drive motor 34. At this point, it should be understood that the location of electric drive motor 34 and battery assembly 38 in vehicle 10 may vary. In a non-limiting example shown in FIG. 2, battery assembly 38 includes a housing 46 having a base wall 50 and a plurality of side walls 52 that define an interior 56 within which is arranged a battery module assembly 58 formed from a plurality of battery modules 60.

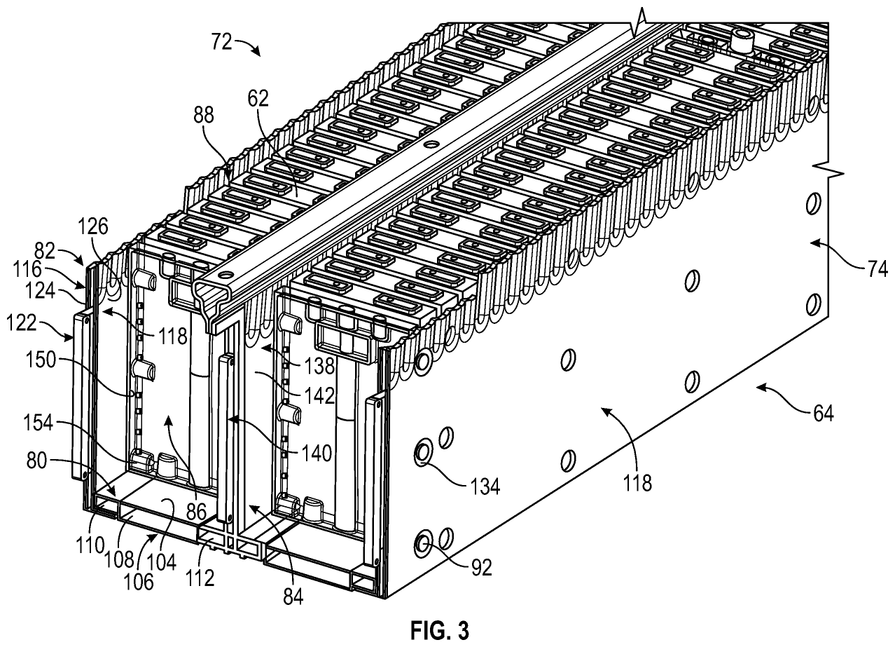

In a non-limiting example, each battery module 60 includes a plurality of battery cells 62 arranged in a row that are connected by an interconnect circuit board (ICB) (not shown). In a non-limiting example, battery module assembly 58 is formed from pairs of battery modules such as shown at 64 in FIG. 3 supported in a first module housing 72 and a second module housing 74. First module housing 72 and second module housing 74 are interconnected. At this point, it should be understood that the number of interconnected module housings may vary.

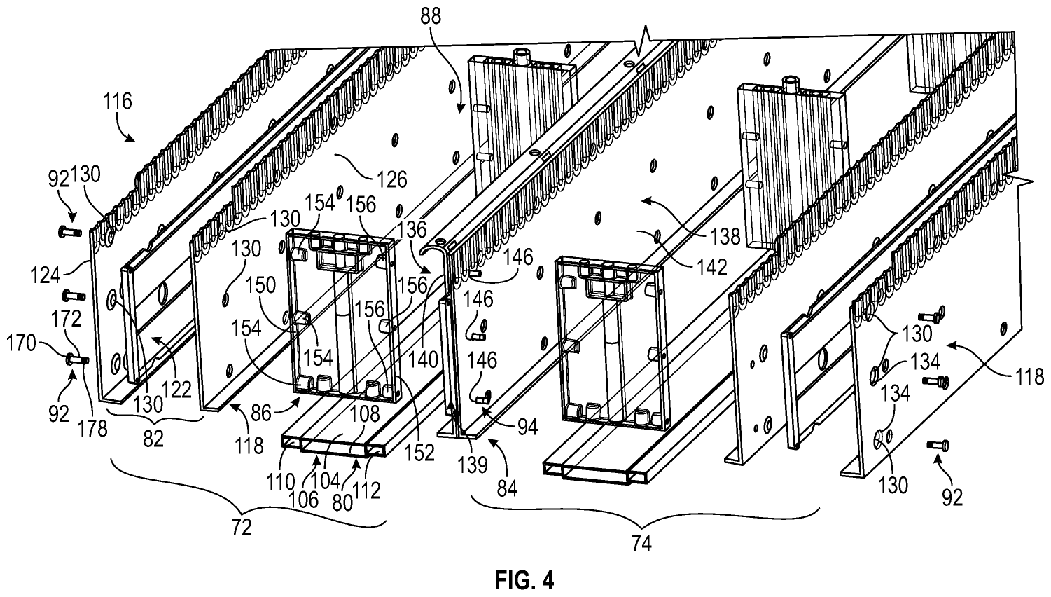

Reference will now follow to FIG. 4, with continued reference to FIG. 3, in describing first module housing 72 in accordance with a non-limiting example with an understanding that second module housing 74 includes similar structure. First module housing 72 includes a base wall 80, a first side wall 82, a second side wall 84, and a plurality of connecting walls 86 that form a plurality of battery cell receiving zones 88. First side wall 82 is joined to connecting wall 86 through a first plurality of connecting elements 92 and second side wall 84 is joined to connecting wall 86 through a second plurality of connecting elements 94. As will be detailed herein, first plurality of connecting elements 92 and second plurality of connecting elements 94 are press-fit into connecting wall 86.

In a non-limiting example, base wall 80 includes a support surface 104 below which are arranged a number of ducts 106 that extend below and run parallel to battery cell receiving zones 88 of first module housing 72. Ducts 106 may include a cooling duct 108 that carries cooling fluid in a heat exchange relationship with base wall 80 below battery cells 62 as well as a first wire chase 110 and a second wire chase 112. First wire chase 110 and second wire chase 112 provide passage for wires (not shown) that may be used in battery assembly 38.

In a non-limiting example, first side wall 82 includes a first side wall member 116 joined to a second side wall member 118. A first cooling member 122 is disposed between first side wall member 116 and second side wall member 118. First side wall member 116 includes a first surface portion 124 and second side wall member 118 includes a second surface portion 126. A first plurality of openings 130 extend through first side wall member 116 and second side wall member 118. First plurality of openings 130 receive corresponding ones of the first plurality of connecting elements 92. In a non-limiting example, an annular recess, such as shown at 134 on first side wall member 116 of second module housing 74, is formed on first surface portion 124 about each opening 130.

Similarly, second side wall 84 includes a first side wall element 136 124 joined to a second side wall element 138. A second cooling member 139 is arranged between first side wall element 136 and second side wall element 138. First side wall element 136 includes a first surface section 140 and second side wall element 138 includes a second surface section 142. A second plurality of openings 146 extend through first side wall element 136 and second side wall element 138. Second plurality of openings 146 accommodate the second plurality of connecting elements 94 as will be detailed herein.

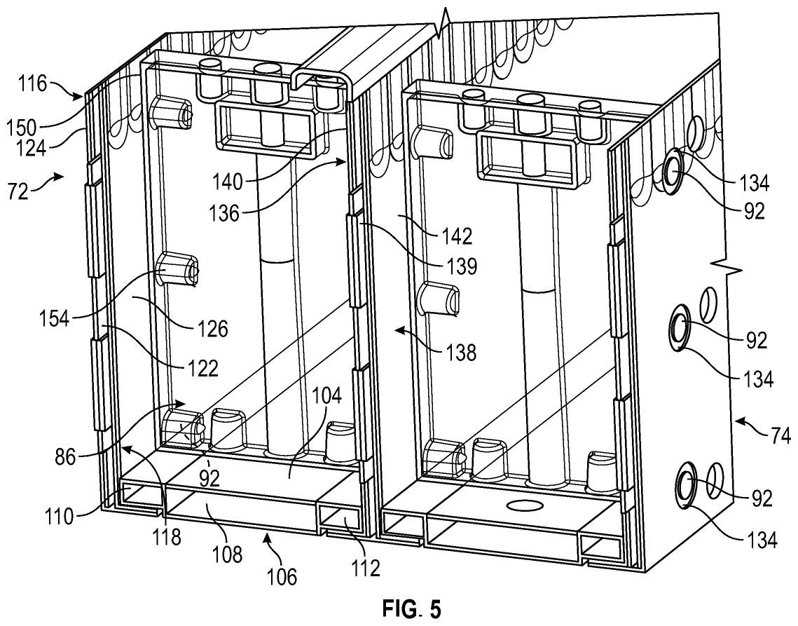

Referring to FIG. 5 and with continued reference to FIG. 4, each connecting wall 86 includes a first side edge 150 that connects with first side wall 82 and a second side edge 152 that connects with second side wall 84. First side edge 150 includes a first plurality of recesses 154 that register with, i.e., align to, first plurality of openings 130. Second side edge 152 includes a second plurality recesses 156 (FIG. 4) that register with, i.e., align to, second plurality of openings 146. As will be detailed herein, the first plurality of connecting elements 92 pass through corresponding ones of openings 130 and are press-fit into respective ones of the first plurality of recesses 154 in first side edge 150 and the second plurality of connecting elements 94 pass through corresponding ones of openings 146 and are press-fit into respective ones of the second plurality of recesses 156 in second side edge 152.

In a non-limiting example, each of the first plurality of connecting elements 92 includes a head portion 170 and a shaft portion 172 as shown in FIG. 4. Shaft portion 172 includes a plurality of gripping elements 178 that may take the form of raised ribs, teeth, or the like. Each of the first plurality of connecting elements 92 pass through each of the plurality of openings 130 with head portion 170 nesting in annular recess 134. Each shaft portion 172 passes into connecting wall 86 and gripping elements 178 engage with walls (not separately labeled) that define the corresponding one of the first plurality of recesses 154. In this manner, first side wall 82 is secured to connecting walls 86.

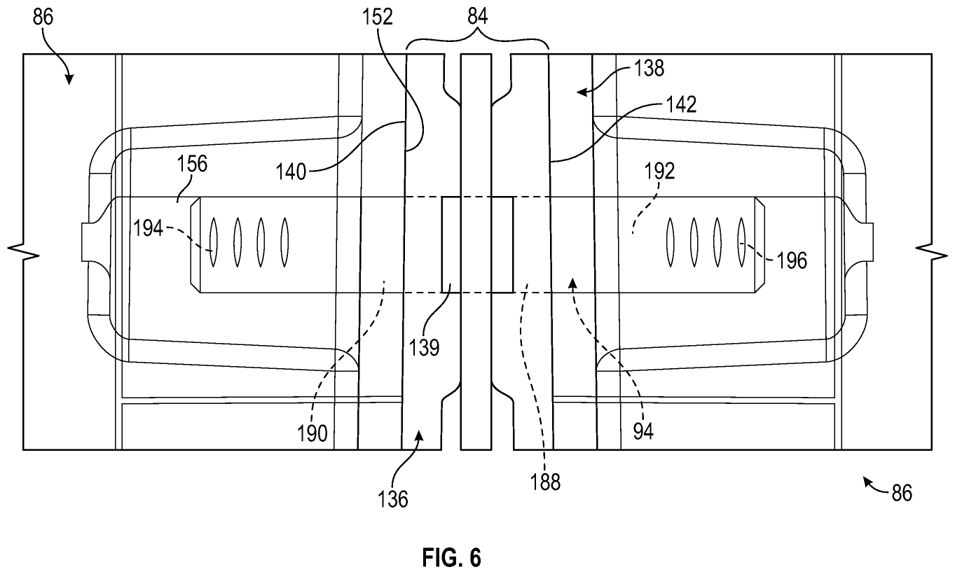

In a non-limiting example, each of the second plurality of connecting elements 94 provides a connection between second side wall 84 and one of the connecting walls associated with first module housing 72 and one of the connecting walls 86 associated with second module housing 74. That is, the second plurality of connecting elements 94 engage with two different connecting walls 86. Toward that end as shown in FIG. 6, each of the second plurality of connecting elements 94 includes a mid-section 188, a first shaft portion 190 and a second shaft portion 192.

In a non-limiting example, first shaft portion 190 extends from mid-section 188 in a first direction and includes a first plurality of gripping members 194 and second shaft portion 192 extends from mid-section 188 in a second direction, opposite the first direction, and includes a second plurality of gripping members 196. The first shaft portion 190 of each of the second plurality of connecting elements 94 extends from corresponding ones of openings 146 into connecting wall 86 with the first plurality of gripping members 194 engaging with walls (not separately labeled) that define the corresponding one of the second plurality of recesses 156.

The second shaft portion 192 of each of the second plurality of connecting elements 94 extends from corresponding ones of openings 146 into an adjacent connecting wall 86. The second plurality of gripping members 196 engage with walls (not separately labeled) that define the corresponding one of the first plurality of recesses 154 of the adjacent connecting wall 86. With this construction, battery module assembly 58 may be readily reconfigured to accommodate different battery designs, battery cell receiving zone size, various battery cell configurations, sizes and the like without the need for a new housing. Thus, the non-limiting example not only increases design possibilities and flexibility but also reduces manufacturing costs.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery module housing comprising:
a base wall;
a first side wall including a first connecting element;
a second side wall including a second connecting element;
a connecting wall extending between the first side wall and the second side wall, the connecting wall including a first side edge including a first recess aligned with the first connecting element and a second edge including a second recess aligned with the second connecting element, wherein the first recess press-fittingly receives the first connecting element and the second recess press-fittingly receives the second connecting element to join the connecting wall to each of the first side wall and the second side wall.

2. The battery module housing according to claim 1, wherein the first side wall includes a first opening, the first connecting element extending through the first opening into the first recess formed in the connecting wall.

3. The battery module housing according to claim 2, wherein the first connecting element includes a head portion and a shaft portion extending from the head portion, the shaft portion including a plurality of gripping elements that engage with the connecting wall in the first recess.

4. The battery module housing according to claim 3, wherein the first side wall includes a first surface portion and a second surface portion opposite the first surface portion, the first surface portion including a recess extending about the first opening, the head portion of the first connecting element being received in the recess.

5. The battery module housing according to claim 2, wherein the second side wall includes a second opening, the second connecting element extending through the second opening into the second recess formed in the connecting wall.

6. The battery module housing according to claim 5, wherein the second connecting element includes a mid-section configured to be received by the second opening, a first shaft section extending from the mid-section in a first direction into the second recess of the connecting wall and a second shaft section extending from the mid-section in a second direction that is opposite the first direction.

7. The battery module housing according to claim 6, wherein the first shaft section includes a first plurality of gripping members that engage with the connecting wall in the second recess and the second shaft section includes a second plurality of gripping members.

8. The battery module housing according to claim 7, wherein the second side wall includes a first surface section joined to the connector member through the first shaft section and a second surface section joined to another connector member through the second shaft section.

9. The battery module housing according to claim 1, wherein the first side wall includes a first side wall member, a second side wall member joined to the first side wall member, and a cooling member extending between and arranged in heat exchange contact with the first side wall member and the second side wall member.

10. The battery module housing according to claim 1, wherein the base wall includes a cooling duct extending substantially parallel to each of the first side wall and the second side wall.

11. A vehicle comprising:
a body including a passenger compartment;
an electric drive motor arranged in the body; and
a battery assembly including a battery module comprising:
a base wall;
a first side wall including a first connecting element;
a second side wall including a second connecting element; and
a connecting wall extending between the first side wall and the second side wall, the connecting wall including a first side edge including a first recess aligned with the first connecting element and a second edge including a second recess aligned with the second connecting element, wherein the first recess press-fittingly receives the first connecting element and the second recess press-fittingly receives the second connecting element to join the connecting wall to each of the first side wall and the second side wall.

12. The vehicle according to claim 11, wherein the first side wall includes a first opening, the first connecting element extending through the first opening into the first recess formed in the connecting wall.

13. The vehicle according to claim 12, wherein the first connecting element includes a head portion and a shaft portion extending from the head portion, the shaft portion including a plurality of gripping elements that engage with the connecting wall in the first recess.

14. The vehicle according to claim 13, wherein the first side wall includes a first surface portion and a second surface portion opposite the first surface portion, the first surface portion including a recess extending about the first opening, the head portion of the first connecting element being received in the recess.

15. The vehicle according to claim 12, wherein the second side wall includes a second opening, the second connecting element extending through the second opening into the second recess formed in the connecting wall.

16. The vehicle according to claim 15, wherein the second connecting element includes a mid-section configured to be received by the second opening, a first shaft section extending from the mid-section in a first direction into the second recess of the connecting wall and a second shaft section extending from the mid-section in a second direction that is opposite the first direction.

17. The vehicle according to claim 16, wherein the first shaft section includes a first plurality of gripping members that engage with the connecting wall in the second recess and the second shaft section includes a second plurality of gripping members.

18. The vehicle according to claim 17, wherein the second side wall includes a first surface section joined to the connector member through the first shaft section and a second surface section joined to another connector member through the second shaft section.

19. The vehicle according to claim 11, wherein the first side wall includes a first side wall member, a second side wall member joined to the first side wall member, and a cooling member extending between and arranged in heat exchange contact with the first side wall member and the second side wall member.

20. The vehicle according to claim 11, wherein the base wall includes a cooling duct extending substantially parallel to each of the first side wall and the second side wall.
